(19) United States
(12) Patent Application Publication
(10) Pub. No.: US 2019/0034886 A1
(43) Pub. Date: Jan. 31, 2019

(54) SYSTEM AND METHOD FOR AUTOMATIC CALENDAR MAINTENANCE

(71) Applicant: UrbanSitter, Inc., San Francisco, CA (US)

(72) Inventors: Lynn Perkins, San Francisco, CA (US); Andrea Barrett, San Francisco, CA (US); Jessica Steel, San Francisco, CA (US)

(21) Appl. No.: 16/145,838

(22) Filed: Sep. 28, 2018

Related U.S. Application Data
(63) Continuation of application No. 14/631,488, filed on Feb. 25, 2015, now abandoned.
(60) Provisional application No. 62/091,337, filed on Dec. 12, 2014.

(51) Int. Cl. G06Q 10/10; H04L 12/58; H04W 4/021

(52) U.S. Cl. CPC G06Q 10/1093; H04L 51/20; H04L 51/046; H04W 4/021

(57) ABSTRACT

A method for automated calendar management for a service provider platform, the method including: associating a set of future timeslots with a first user account, the set of future timeslots cooperatively representing a first time period, wherein each future timeslot is associated with a unique time and date; receiving a scheduling request from a second user account different from the first user account, the scheduling request identifying a first future timeslot; sending an availability query based on the scheduling request to the first user account; in response to receipt of a decline response to the availability query from the first user account, assigning an unavailable status to the first future timeslot; and in response to receiving an accept response to the availability query from the first user account, assigning a booked status and an identifier for the second user account to the first future timeslot.

### CROSS REFERENCE TO RELATED APPLICATIONS

This application is a continuation of U.S. application Ser. No. 14/631,488, filed 25 Feb. 2015, which claims the benefit of U.S. Provisional Application No. 62/091,337 filed 12 Dec. 2014, each of which is incorporated in its entirety by this reference.

### TECHNICAL FIELD

This invention relates generally to the scheduling field, and more specifically to a new and useful system and method for automated service provider calendar maintenance in the scheduling field.

### BRIEF DESCRIPTION OF THE FIGURES

FIG. 1 is a flowchart diagram of a variation of the method including assigning an unavailable status to a timeslot in response to a first user account declining a scheduling request from a second user account.

FIG. 2 is a flowchart diagram of a variation of the method including degrading the editable time period associated with the first user account in response to the first user account activity on the platform falling below a parameter threshold.

FIG. 3 is a schematic representation of a variation of the method including returning available primary user account identifiers in response to a search for a timeslot, receiving a scheduling request for a first user account for a first timeslot from a second user account, generating the availability query for the first user account based on the scheduling request, assigning a booked status with the timeslot in response to receipt of an accept request, assigning an unavailable status with the timeslot in response to receipt of a decline request, and not returning the first user account identifier in response to receipt of a search for the timeslot.

FIG. 4 is a schematic representation of a variation of the method including assigning unavailable status to a first timeslot in response to receipt of a cancellation of a booking for the first timeslot, assigning an editable unavailable status to a second timeslot in response to receipt of an availability retraction notification (unavailable notification) for the second timeslot from the first user account, and assigning an available status to a second timeslot in response to receipt of an availability enablement notification for the second timeslot from the first user account.

FIG. 5 is a schematic representation of a timetable including a set of editable and non-editable timeslots, wherein the editable timeslots cooperatively define a time period.

FIG. 6 is a schematic representation of a variation of the method including adding new editable timeslots to the set of editable timeslots or extending the editable timeframe associated with the first user account.

FIG. 7 is a schematic representation of a variation of the method including populating new timeslots with status patterns identified from past timeslots.

FIGS. 8A and 8B are a schematic representations of a variation of the method for a first and second primary user account, including extending the editable timeframe for the first primary user account, associated with a first timetable 161′, in response to the activity parameter of the first primary user account meeting or surpassing the parameter threshold, and preventing timeframe extension for the second primary user account, associated with a second timetable 161″, in response to the activity parameter of the second primary user account failing the parameter threshold, respectively.

FIG. 9A is a schematic representation of a variation of the method including receiving a geographic location from a user device associated with a first user account at a first time, maintaining the respective timeslot statuses in response to determination that the user location is within the first geographic region 520′, presenting available timeslots as available in a result to a search 300′ from a second user account associated with the first geographic region 520′, and presenting available timeslots as unavailable in a result to a search 300″ from a second user account associated with the first geographic region 520″.

FIG. 9B is a schematic representation of a variation of the method including receiving a geographic location from a user device associated with a first user account at a first time, adjusting the respective timeslot statuses in response to determination that the user location is outside of the first geographic region 520′, presenting available timeslots as unavailable in a result to a search 300′ from a second user account associated with the first geographic region 520′, and presenting available timeslots as available in a result to a search 300″ from a second user account associated with the first geographic region 520″.

FIGS. 10A and 10B are schematic representations of a variation of the method wherein the first user account is selectively available for scheduling requests associated with a first and second geographic region at a first and second time, respectively.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

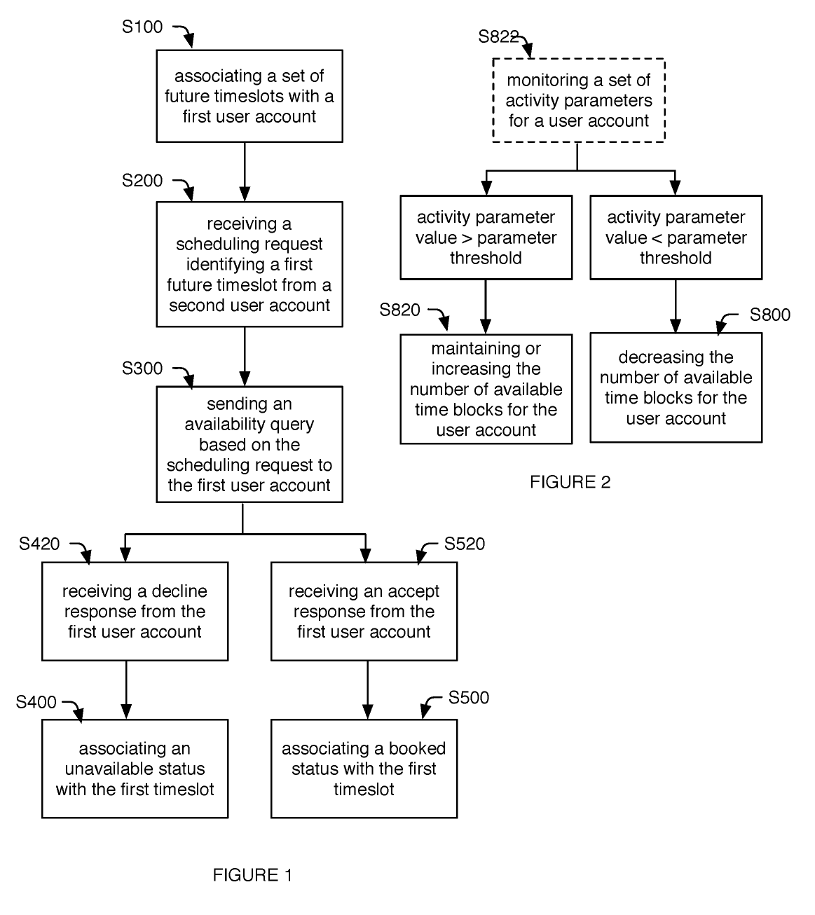

As shown in FIG. 1, the method for automated calendar management on a service provider platform includes: associating a set of future timeslots with a first user account S100; receiving a scheduling request identifying a first future timeslot from a second user account S200; sending an availability query based on the scheduling request to the first user account S300; in response to receiving a decline response to the availability query from the first user account S420, assigning an unavailable status to the first future timeslot S400; and in response to receiving an accept response to the availability query from the first user account S520, assigning a booked status and an identifier for the second user account to the first future timeslot S500. The method functions to automatically determine a service provider's unavailable timeslots, such that the unavailable timeslots do not appear in a search for service providers' availabilities during the timeslot.

In a specific example of the method, the service provider platform receives a job request associated with a first time and date from a job provider, returns a list of caretakers (e.g., babysitters) having available timeslots at the time and date, receives a selection for the caretaker from the job provider, and generates a scheduling query for the caretaker specifying the timeslot and job request in response to caretaker selection. The timeslot for the caretaker is marked booked if the caretaker accepts the job request. The timeslot for the caretaker is marked unavailable if the caretaker declines the job request, wherein the caretaker will be unable to accept other jobs for that timeslot.

The inventors have discovered that maintaining substantially up-to-date or accurate availability calendars for service providers is of substantial importance in a service provider platform that connects service providers with service seekers. This is because up-to-date availability calendars can foster trust in service seekers, while out of date or inaccurate availability calendars can foster distrust or frustration in service seekers, eventually leading to service seeker abandonment of the service provider platform. This can be particularly important for services that require a high level of trust, such as care provision, and/or time-sensitive services, such as babysitting scheduling. The inventors have also discovered that users (e.g., the service providers using the system) oftentimes do not proactively update their associated calendars, but will respond to queries sent to their respective user accounts or devices. This method substantially automatically updates the service providers' respective calendars by inferring availability based on the service provider response to the query.

This method can additionally gamify proactive calendar updates, wherein the service provider can be penalized for cancelling a job or not having an up-to-date calendar, and be rewarded for proactively updating their calendar. The service providers can be penalized by limiting service provider editing of timeslots marked as unavailable (e.g., wherein the service provider cannot edit the unavailable status of the timeslot), reducing the future time period that the service provider can edit or schedule (e.g., reducing the editable timeframe from 4 months to 2 months), reducing a score or ranking associated with the service provider that is visible by service seekers, lowering the service provider position in a service provider list provided in response to a query, or penalizing the service provider in any other suitable manner. The service providers can be rewarded by enabling service provider editing of timeslots marked as unavailable (e.g., wherein the service provider can edit the unavailable status of the timeslot), increasing the future time period that the service provider can edit or schedule (e.g., increasing the editable timeframe from 2 months to 4 months), increasing a score or ranking associated with the service provider that is visible by service seekers, increasing the service provider position in a service provider list provided in response to a query, or rewarding the service provider in any other suitable manner.

The service provider platform 100 performing the method functions to connect a first set of user accounts (primary user accounts) 120 with a second set of user accounts (secondary user accounts) 140. The first set of user accounts are preferably associated with service providers, but can alternatively be associated with any other suitable entity. The second set of user accounts are preferably associated with service seekers, but can alternatively be associated with any other suitable entity. The service provider platform can function as a social networking system, wherein multiple user accounts (e.g., from the first and/or second set) can be directly connected (e.g., associated as “friends” or “contacts”), be indirectly connected (e.g., through an intermediary user account commonly connected to both user accounts), be connected through an external resource (e.g., a secondary social networking system), or be connected in any other suitable manner.

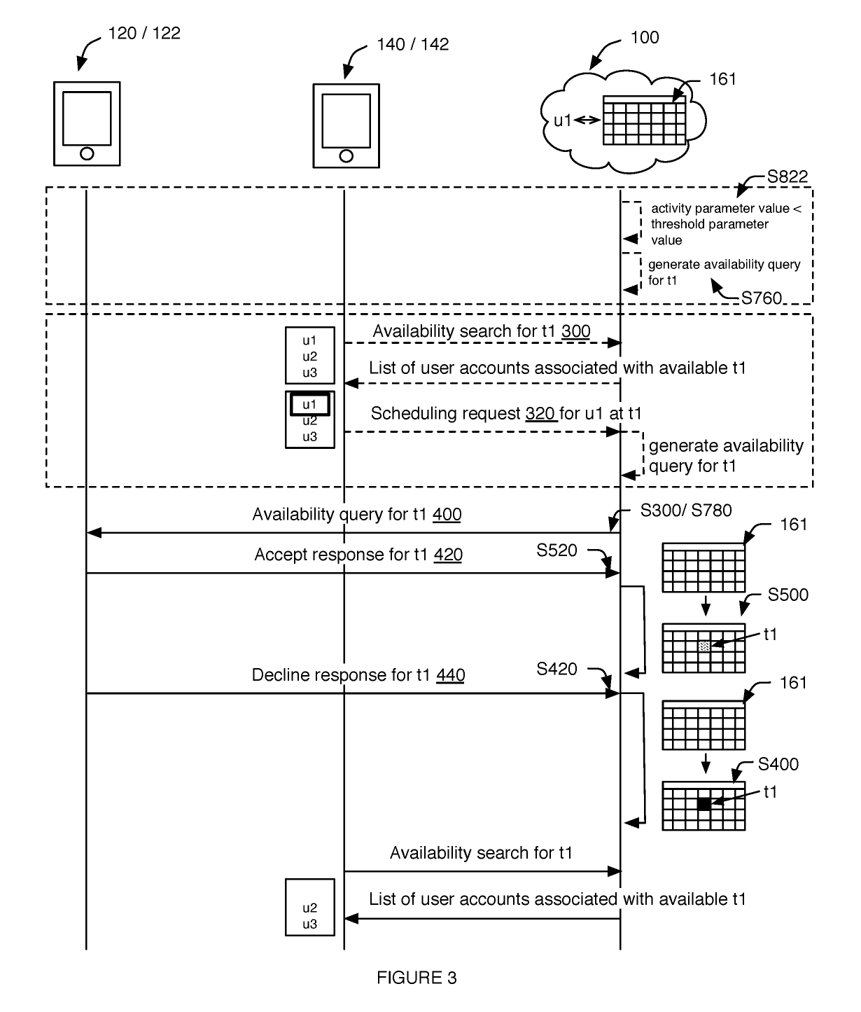

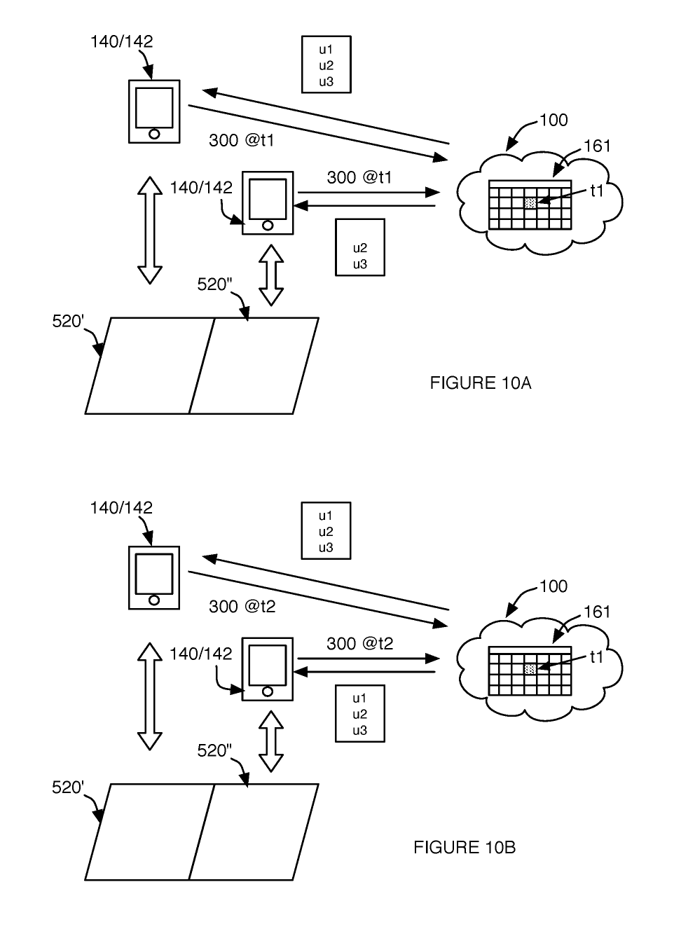

Each account on the service provider platform can be associated with a timetable 161, a profile, contact preferences, a score, an activity history, and/or any other suitable information. Each timetable 160 is preferably formed from a set of contiguous or non-contiguous timeslots or time blocks 170, but can alternatively have any other suitable construction. The timetable 160 is preferably a calendar, but can alternatively be any other suitable timetable. The profile of a user account can include a user account identifier (e.g., a name), contact information, a geographic region or location, or any other suitable information. The contact preferences can include a set of preferred contact methods (e.g., E-mail, SMS, MMS, message through the service provider platform, message through a secondary social networking system, etc.), a set of disfavored contact methods, or any other suitable set of contact preferences. The score can be a public score (e.g., presented to secondary user accounts) or an internal score (e.g., not presented to secondary user accounts). The score can be determined based on activity parameters, ratings from one or more of the secondary set of user accounts, or based on any other suitable parameter. The score can be used to determine whether the user account should be returned in response to a query by a secondary user account (e.g., of the secondary set of user accounts), the position of the user account in the returned list, or determine any other user account presentation parameter. The activity history can be the history of user account activity on the service provider platform, and can include parameters (e.g., time, duration, location, actions taken, etc.) of user account platform access, parameters of calendar access or calendar editing, parameters of user account interaction with other user accounts, or parameters of any other suitable user account activity on the platform. As shown in FIG. 3, in response to receipt of an availability search request 300 from a secondary user account (e.g., a service seeker) for a timeslot, the platform can identify and present identifiers for primary user accounts (e.g., service provider accounts) associated with an available status for the identified timeslot to the secondary user account. The primary user account results can additionally be filtered based on primary user account preferences (e.g., geographic location preferences, time preferences, preferences for secondary user accounts, etc.), as shown in FIGS. 10A and 10B, secondary user account preferences (e.g., geographic location preferences, education preferences, score preferences, etc.), or filtered or organized by any other suitable variable.

The service provider platform 100 is preferably supported by a remote system, but can alternatively be supported by a distributed network (e.g., mesh network) of user devices or supported in any other suitable manner. Each user account of the service provider platform is preferably associated with one or more user devices, but can alternatively be assorted with any other suitable computing system. For example, the primary user accounts can be associated with a first set of user devices 122, and the secondary user accounts can be associated with a second set of user devices 142, different from the first set. Each user device can include a data input (e.g., a touchscreen, keyboard, pointing device, microphone, etc.), data output (e.g., speakers, display, etc.), set of sensors (e.g., light sensor, sound sensor, orientation sensor, such as an accelerometer or gyroscope, location sensor, such as a GPS unit, triangulation unit, etc.), or any other suitable component.

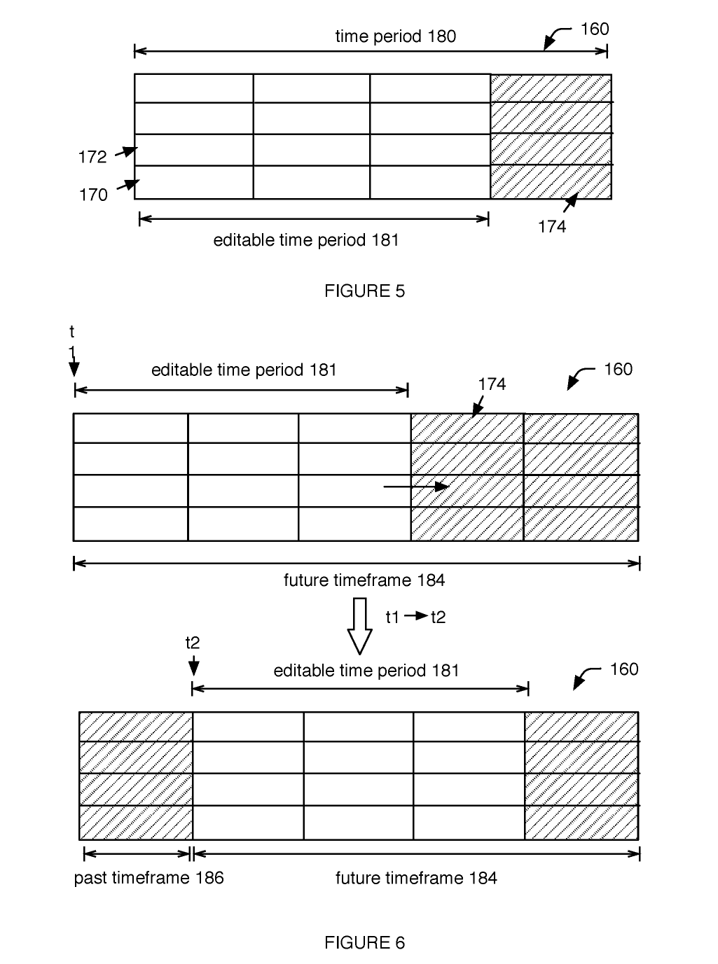

The timetable 161 associated with the user account functions to track the availability of the service provider associated with the user account. The timetable 160 can additionally function to limit how far into the future the user account can schedule (e.g., by limiting the number of future editable timeslots 172 available for user account editing). As shown in FIG. 5, the timetable 160 preferably includes one or more timeslots 170. The timetable 160 preferably includes a data structure (e.g., chart) showing relationships between different timeslots, but can alternatively have any other suitable structure. The timetable 160 can be a virtual calendar, wherein the timetable 160 can be associated with a set of unique times and dates, or can be generic or recurrent. In one variation, the timetable associated with each user account preferably includes a set of editable timeslots 172, wherein the editable timeslots 172 cooperatively define an editable time period 181. The editable time period 181 can be limited to a predetermined time period limit or be unlimited. The editable time period 181 can be dynamically adjusted based on user account actions. For example, the editable time period 181 can be decreased in response to cancellations or decline responses received from the user account. The predetermined time period limit can be substantially static, dynamically adjusted (e.g., based on user account actions), or otherwise determined. The editable time period 181 and/or predetermined time period limit can be the same or different for a first and second user account. Alternatively, the time period 180 covered by the time table 160 (e.g., timetable period) can be different from the editable time period 181, wherein timeslots 170 within the editable time period 181 can be edited, and timeslots 170 outside the editable time period 181 but within the timetable period cannot be edited by the user account.

The timetable 160 associated with the user account preferably includes a set of timeslots (time blocks) 170, wherein each timeslot 170 represents a unit of time, or a timeslot time duration. The timeslots 170 of a timetable 160 preferably represent the same time duration (e.g., wherein each timeslot represents 30 minutes), but can alternatively represent different time durations (e.g., wherein a first timeslot represents 30 minutes, and a second timeslot represents 45 minutes). The timeslots 170 are preferably generic (e.g., represent only a magnitude of time), but can alternatively be recurrent and associated with a recurring time (e.g., Mondays from 1 PM-2 PM), be substantially unique and associated with a unique time and date (e.g., Oct. 28, 2014 at 2 PM), or have any other suitable identification parameter. The timeslots 170 can be designated as a future timeslot, past timeslot, or current timeslot, relative to a reference time. The reference time is preferably an instantaneous time (e.g., the time at which the process is performed), but can alternatively be any other suitable time. The time can be an absolute time, including a date and time, a relative time, or any other suitable time. Future timeslots are preferably associated with times after the reference time, past timeslots are preferably associated with times prior the reference time, and current timeslots are preferably associated with the reference time. However, the future, past, and current timeslots can be otherwise defined. However, the timeslots can have any other suitable designation.

The timeslots 170 can be editable 172, non-editable 174, or otherwise assignable to a status. Statuses can include an available status 200, booked status 230, or unavailable status 220 (e.g., editable 221 or non-editable 222), but can additionally or alternatively include any other suitable status. A timeslot 170 having an available status 200 can result in the associated user account to be returned in a search for service providers that are available during that timeslot, can be booked by a secondary user account, or be used in any other suitable manner. The timeslot 170 can be associated with the available status 200 by default (e.g., when editing of the timeslot is enabled for the user account), in response to receipt of an available status for the timeslot from the user account, in response to a cancellation request received from a secondary user account associated with the timeslot (e.g., a service seeker that had booked the timeslot), or be associated with the available status in response to the occurrence of any other suitable event.

A timeslot 170 having a booked status 230 can be used to generate reminder notifications, track service provision, generate billing requests, or used in any other suitable manner. The booked status 230 can additionally include or be associated with a secondary user account identifier (e.g., the secondary user account booking the timeslot of the service provider), a location (e.g., where the service is to be performed), or any other suitable job-related information. Booked timeslots 230 can be treated as unavailable timeslots for search purposes (e.g., wherein the user account having the booked timeslot does not appear as a result to a search for available service providers during a timeslot), but can alternatively be treated as an available timeslot for search purposes, or be treated in any other suitable manner. The timeslot 170 can be associated with the booked status 230 in response to receipt of a scheduling request received from a secondary user account identifying the timeslot, in response to receipt of an accept response to an availability query 400 generated by the system based on a scheduling request received from a secondary user account identifying the timeslot, or be associated with the booked status in response to the occurrence of any other suitable event.

A timeslot 170 having an unavailable status 220 preferably prevents the associated user account from appearing as a result to a query for service providers available during the timeslot, but can alternatively be used in any other suitable manner. A secondary user account (e.g., the service seeker) preferably cannot book the unavailable timeslot. The user account (e.g., the service provider) is preferably also incapable of booking a secondary user account for the unavailable timeslot. The unavailable status 220 can additionally be associated with an unavailability source (e.g., the reason why the timeslot was associated with an unavailable status), wherein timeslot status reassignment (e.g., from unavailable to available) can be selectively enabled or disabled based on the source. The timeslot 170 can be manually or automatically associated with the unavailable status. The timeslot 170 can be manually associated with the unavailable status in response to an unprompted status assignment by the user account (e.g., proactive scheduling or calendar management) or otherwise manually associated with the unavailable status. When the unavailable status was manually assigned to the timeslot, the unavailable status is preferably editable 221 (e.g., the user account associated with the timeslot can change the timeslot status), but can alternatively be non-editable 222 or have restricted editing permissions. The timeslot 170 can be automatically associated with the unavailable status in response to the service provider declining a scheduling request from a service seeker (e.g., a decline response in response to an availability query 400 generated based on a scheduling request 320 from a secondary user account), in response to a cancellation (e.g., an input cancelling a booking that is manually entered or received in response to an automatically generated reminder or confirmation notification), in response to the service provider indicating that they will be unavailable during a specified time period (e.g., an unavailable response in response to an availability query automatically generated by the system), or in response to any other suitable indication that the service provider will be unavailable during the timeslot. In this variation, the timeslot 170 can be associated with a non-editable (uneditable) unavailability status 222, but can alternatively be associated with an editable unavailability status 221 or any other suitable status. The timeslot status editing permissions can be determined based on the unavailability source or be independent of the unavailability source (e.g., always be uneditable, etc.). For example, when the timeslot was marked unavailable in response to a cancellation or job rejection, the timeslot can be uneditable (e.g., the unavailable status associated with the timeslot cannot be changed by the service provider), while timeslots manually marked unavailable or marked unavailable in response to an availability query can remain editable.

One or more timeslots 170 cooperatively define a time period 180. The editable timeslots 172 (e.g., timeslots that the user account can associate statuses and/or other information with) of the timetable preferably cooperatively define an editable time period 181. The time period 180 is preferably a magnitude of time encompassing one or more units of time, but can be alternatively defined. For example, the available time period for a user account can be 4 months, formed from multiple 30-minute editable timeslots. The time period 180 is preferably generic, but can alternatively be recurrent, associated with a unique time and date, or have any other suitable identification parameter. When associated with a unique time and date, the time period 180 preferably cooperatively defines a time frame 182. The timeframe 182 is preferably a time period that extends from a reference time (e.g., an instantaneous time), but can alternatively be defined in any other suitable manner. However, the time period can be defined in any other suitable manner. The timeframe 182 can be a future timeframe 184, wherein the future timeframe 184 includes a time period 180 after a reference time, a past timeframe 186, wherein the past timeframe 186 includes a time period 180 before a reference time, an instantaneous timeframe, wherein the instantaneous timeframe includes a time period 180 encompassing the reference time, or be any other suitable timeframe 182.

Associating a set of timeslots with a first user account S100 functions to associate a timetable with the first user account. The timeslots are preferably future timeslots, but can alternatively be past timeslots, current timeslots, or any other suitable timeslot. The set of timeslots preferably cooperatively represent a first time period, wherein the first time period can be predetermined, dynamically determined, or otherwise determined. The timeslots within the set of timeslots are preferably contiguous and non-overlapping, but can alternatively overlap, be non-contiguous, or have any other suitable relationship. The timeslots are preferably each associated with a unique time and date, but can alternatively be generic or have any other suitable property. The set of timeslots are preferably associated with the first user account upon user account initiation, but can alternatively be associated with the first user account upon the occurrence of any other suitable event. A single timetable is preferably associated with the first user account, but any other suitable number of timetables can be sequentially or concurrently associated with the first user account. The timetable is preferably updated with new timeslots with the passage of time and/or satisfaction of parameter conditions, but a new timetable can alternatively be associated with the first user account to give the first user account access to new timeslots. However, editing access to new timeslots can be otherwise enabled for the first user account.

As shown in FIG. 3, receiving a scheduling request identifying a first future timeslot from a second user account S200 functions to receive a request to book the service provider associated with the first user account for the first future timeslot. The first future timeslot can be one of multiple timeslots identified by the scheduling request (e.g., wherein the scheduling request can be for one or more contiguous or non-contiguous timeslots). The second user account is preferably different from the first user account, but can alternatively be any other suitable account. The second user account is preferably associated with a different entity from the first user account (e.g., a service seeker and service provider, respectively), but can alternatively be any other suitable entity. The scheduling request is preferably received by the service provider platform, but can alternatively be received by a user device associated with the first user account or by any other suitable computing system. The scheduling request can include an identifier for the first future timeslot (e.g., the unique time and date combination), an identifier for the second user account, an identifier for the first user account, job information (e.g., job parameters, special requests, etc.), or any other suitable information. The scheduling request is preferably received in response to selection of a scheduling element (e.g., scheduling icon) by the second user account, but can alternatively be received in response to automatic scheduling request generation by the platform (e.g., wherein the platform learns the second user account habits based on past second user account history and automatically generates job requests on the second user account's behalf), or in response to the occurrence of any other suitable scheduling event.

Sending an availability query based on the scheduling request to the first user account S300 functions to notify the service provider that the service seeker is attempting to book the available timeslot. Sending the availability query can include generating the availability query based on the scheduling request and sending the availability query. Generating the availability query based on the scheduling request can include extracting some or all of the scheduling information (e.g., first timeslot identifier, second user account identifier, job information, etc.) from the scheduling request and including the extracted scheduling information in the availability query. The availability query can be substantially similar to the scheduling request, include less information than the scheduling request, include more information than the scheduling request (e.g., include links to the second user account, etc.), or include any other suitable information.

The availability query 400 can additionally include an availability element, wherein selection of the availability element can generate and send an availability response to the platform. The availability element can include an accept element and decline element (e.g., icon or virtual space), wherein selection of the accept element sends an accept response 420 to the service provider platform, and selection of the decline element sends a decline response 440 to the service provider platform, respectively. However, the availability query can generate any other suitable element and generate any other suitable response. The accept and decline elements can each be a separate icon on the availability query interface, wherein selection of the icon at the user device generates the respective response. Alternatively, the accept and decline elements can each be a virtual space on opposing sides of the availability query interface, wherein receipt of a substantially continuous motion in a first direction generates the accept response, and receipt of a substantially continuous motion in a second direction opposing the first generates the decline response. The first and second directions can be substantially parallel to the availability query text alignment, substantially perpendicular to the availability query text alignment, be a first and second rotational direction, or be any other suitable direction. Alternatively, the accept and decline elements can be selected in response to receipt of a first and second action, respectively. The first and second actions are preferably different or opposing actions, but can alternatively be the same action with differing parameters (e.g., hold duration). Examples of actions that can be used include a tap, swipe, rotation, or any other suitable interaction that can be received at the user input.

The method can additionally include presenting a reason identification form to the first user account in response to receipt of a decline response, receiving a reason (e.g., a reason selection, typed reason, etc.) for the decline response from the first user account, and associating the reason with the first user account. The reasons associated with the first user account can subsequently be analyzed (e.g., using machine learning techniques) and used to filter which service providers show up in response to a search by a service seeker. For example, service providers that historically declined jobs that were outside of a predetermined radius of a home location can be filtered out of a list of available service providers returned in response to a search by a service seeker located outside of the predetermined radius of the service provider home location. The timeslot is preferably assigned an unavailable status, more preferably a non-editable unavailable status but alternatively an editable unavailable status, in response to receipt of the decline request, such that the identified reason does not influence the status assignment. Alternatively, the unavailable status can be assigned in response to receipt of a first set of decline reasons and not assigned in response to receipt of a second set of decline reasons, wherein the first set can overlap with the second set or be exclusive from the second set. Alternatively, an editable unavailable status can be assigned in response to receipt of a first set of decline reasons and a non-editable unavailable status can be assigned in response to receipt of a second set of decline reasons, wherein the first set can overlap with the second set or be exclusive from the second set. However, the decline reason can be utilized in any other suitable manner.

Assigning an unavailable status to the first future timeslot S400 in response to receiving a decline response to the availability query from the first user account S420 functions to prevent or otherwise limit the first user account from being returned in future queries for the timeslot. This has a twofold effect. First, the system infers that the service provider will be unavailable during the first timeslot, because they have turned down a job opportunity during the timeslot. This can prevent or otherwise limit future availability queries for the timeslot from being sent to the service provider, which can function to limit service provider information overload. Second, the system promotes service provider job acceptance, which results in a higher probability that a service seeker will be able to book a service provider. This can result in higher service seeker satisfaction with the service platform, which can promote service seeker use of the platform. The unavailable status is preferably automatically assigned by the platform in response to receipt of the decline response, but can alternatively be automatically assigned by the user device receiving the decline response, manually assigned by the first user account, or assigned by any other suitable system.

Assigning a booked status and an identifier for the second user account to the first future timeslot S500 in response to receiving an accept response to the availability query from the first user account functions to book the service provider for the timeslot S520. The booked timeslot can additionally be associated with an identifier for the service seeker (e.g., the second user account identifier, such as a username, link to the second user account, etc.). The booked timeslot can additionally be associated with the scheduling request information, second user account information (e.g., address, rating, etc.) extracted from a profile associated with the second user account, an external social networking system, or from another information source, or any other suitable information. The booked timeslot can additionally be associated with more timeslots than the timeslots identified by the scheduling request. More preferably, one or more timeslots contiguous with the timeslots identified in the scheduling request can be associated with the booked status, such that the total booked time period is longer than the scheduled time period. This can function to accommodate for travel time, habitual delays, or accommodate for any other suitable activity. The extra time period can be automatically determined, specified by the first user account, or otherwise determined. The extra time period can be automatically determined based on historical actions (e.g., wherein the platform can determine travel time or delays based on historical user locations associated with the user account, received by the platform or user device from a location module, such as a GPS unit), based on population information (e.g., the average amount of time required to travel from a first address, such as a home address, to a job address, determined based on historical travel information for a population of users), or based on any other suitable set of information. However, any suitable number of timeslots can be assigned with the booked status.

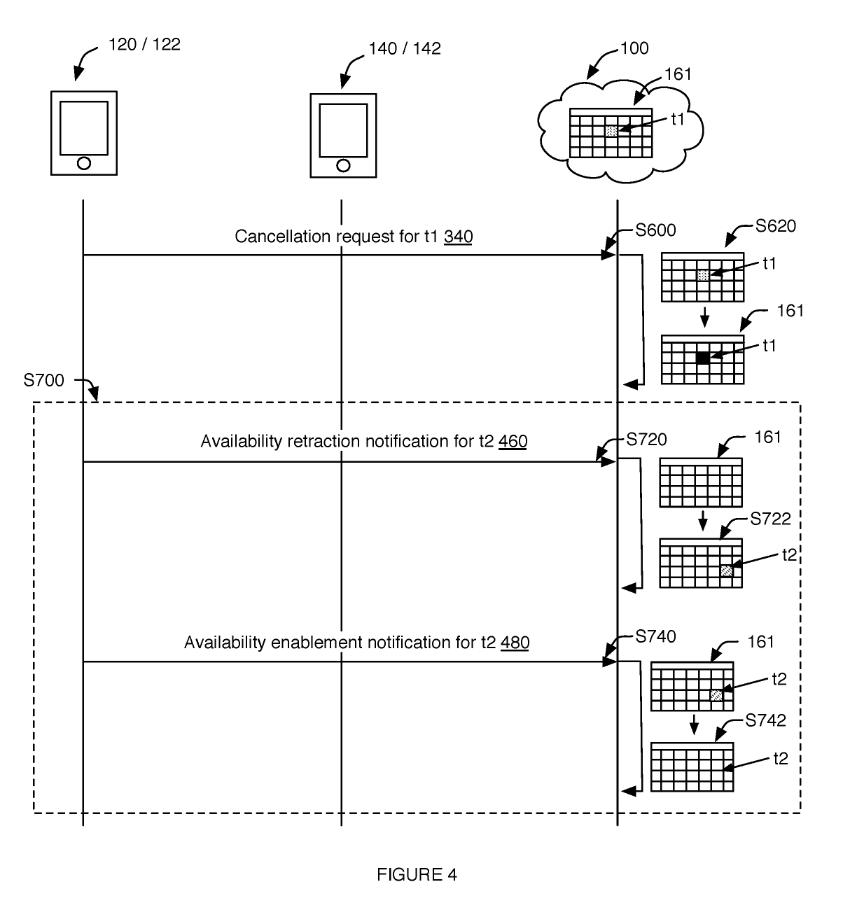

As shown in FIG. 4, the method can additionally include receiving a cancellation request from the first user account for a booked timeslot associated with a booked status S600, disassociating the booked timeslot from the booked status in response to receipt of the cancellation request, and assigning an unavailable status to the booked timeslot in response to receipt of the cancellation request S620. The unavailable status is preferably non-editable, but can alternatively be editable. The unavailable status assignment S620 can be substantially similar to the unavailable status assignment in response to a declined response S400, but can alternatively be different. This can function to deter service providers from cancelling booked jobs. The cancellation request 340 can be associated with an automatically generated confirmation query sent to the first user account, wherein the cancellation request can be received in response to the confirmation query. The confirmation query can be generated and/or sent a predetermined period of time before the booked timeslot (e.g., a day before the booked timeslot), in response to a confirmation event (e.g., an activity parameter of the first user account falling below a parameter threshold), or generated and/or sent at any other suitable time. Alternatively, the cancellation request can be unprompted (e.g., not associated with a confirmation query). However, the cancellation request can be otherwise received. If no response is received in response to the confirmation query, the timeslot can retain the booked status, or be assigned an unavailable status. In the latter case, a cancellation notification can additionally be sent to the second user account associated with the booked timeslot. However, the timeslot can be otherwise adjusted based on the response to the confirmation query.

The method can additionally include adjusting a score (e.g., decreasing the score) associated with the first user account in response to receipt of the cancellation request. The score is preferably determined based on the activity parameters of the first user account, but can be otherwise determined. The score is preferably used to determine the order in which multiple service providers (e.g., user accounts of the first set) appear in a search result, but can additionally or alternatively be otherwise used.

The method can additionally include identifying a set of replacement user accounts associated with available timeslots sharing the time and date of the previously booked timeslot in response to receipt of the cancellation request. This can function to present substitute service providers to the service seeker for the cancelled timeslot. The identified set of replacement user accounts is preferably user accounts connected to the first user account on the service provider platform, but can alternatively be any other suitable set of user accounts. The identified set of replacement user accounts are preferably directly connected to the first user account, but can alternatively be indirectly connected or otherwise associated with the first user account.

The method can additionally include generating and/or sending a notification to the second user account associated with the previously booked timeslot, which can function to notify the second user account that the first user account has cancelled the booking. The notification can additionally include identifiers (e.g., names, links, etc.) to the identified set of replacement user accounts, a reason supplied by the first user account for the cancellation, or any other suitable information.

As shown in FIG. 4, the method can additionally include receiving a manual status assignment to a set of editable timeslots S700, which functions to selectively include or exclude the first user account from being presented in a list of available service providers in response to a search. The manual status adjustment is preferably received from the first user account, but can alternatively be received from an administrator or from any other suitable account with edit permissions. Receiving a manual status assignment to a set of editable timeslots S700 can include receiving an availability retraction notification from the first user account S720 and assigning an unavailable status to a first future timeslot of the first set identified by the time and date S722. Receiving a manual status assignment to a set of editable timeslots S700 can additionally or alternatively include receiving an availability enablement notification from the first user account S740, determining whether the timeslot is associated with an editable status, and assigning an unavailable status to the editable timeslot identified by the time and date S742 in response to determination that the timeslot can be associated with an available status.

Receiving an availability retraction notification identifying a timeslot from a first user account S720 functions to receive a notification indicating that the service provider will be unavailable during the time represented by the timeslot. The availability retraction notification 460 is preferably generated by the user device associated with the first user account, but can alternatively be generated by the platform (e.g., based on historical patterns of unavailability, based on a second calendar associated with the first user account, etc.), or generated in any other suitable manner. The availability retraction notification 460 preferably includes a timeslot identifier. The timeslot identifier preferably includes a time and date, more preferably a unique time and date, but can alternatively include any other suitable identifier. The availability retraction notification 460 can additionally include retraction information, such as a reason for the unavailability, whether the unavailability will be a repeating unavailability, or any other suitable retraction information.

Assigning an unavailable status to the identified timeslot S722 functions to prevent or otherwise limit the first user account from being returned in future queries for the timeslot. The unavailable status is preferably an editable unavailable status, but can alternatively be an uneditable unavailable status. The source of the unavailability status (e.g., manual assignment) can additionally be stored in association with the timeslot. The unavailability status assignment is preferably different from S400 or S620, but can alternatively be substantially similar.

Receiving an availability enablement notification identifying a timeslot from the first user account S740 functions to receive a notification indicating that the service provider will be available during the time represented by the timeslot. The availability enablement notification 480 is preferably generated by the user device associated with the first user account, but can alternatively be generated by the platform (e.g., based on historical patterns of unavailability, based on a second calendar associated with the first user account, etc.), or generated in any other suitable manner. The availability enablement notification 480 preferably includes a timeslot identifier. The timeslot identifier preferably includes a time and date, more preferably a unique time and date, but can alternatively include any other suitable identifier. The availability enablement notification 480 can additionally include enablement information, such as a reason for the unavailability, whether the unavailability will be a repeating unavailability, or any other suitable enablement information.

Determining whether the timeslot is associated with an editable status functions to determine whether the timeslot status can be associated with an available status. Determining whether the timeslot is associated with an editable status includes determining the timeslot status, and in response to determination that the timeslot status is an unavailable status, determining whether the unavailable status is an editable status or an non-editable status, but can alternatively be determined in any other suitable manner. Determining whether the unavailable status is an editable status or an non-editable status can include identifying the source of the unavailable status, wherein status editing can be prevented if the unavailable status was a result of a first set of sources (e.g., a decline request or a cancellation request) and enabled if the unavailable status was a result of a second set of sources (e.g., automatic unavailability assignment based on an external calendar, pattern propagation, or manual assignment). Alternatively, determining whether the unavailable status is an editable status or a non-editable status can include reading an edit status tag associated with the unavailable status, wherein the edit status tag can identify the unavailable status as an editable or non-editable status. Alternatively, the unavailable timeslot can always be editable or uneditable, wherein the method does not include determining whether the timeslot is associated with an editable status.

Assigning an available status to the identified timeslot S742 functions to enable the first user account to be returned in future queries for the timeslot. The available status is preferably assigned in response to receipt of the availability enablement notification and determination that the timeslot status is editable, but can alternatively be assigned in response to any other suitable status adjustment event.

As shown in FIGS. 2, 6, 7, 8A, 8B, 9A, and 9B, the method can additionally include gradually reducing the number of editable future timeslots associated with the first user account or limiting the number of timeslot additions to the set of future timeslots S800, such that a time period cooperatively defined by remaining future timeslots of the first set decreases over time. This can function to passively remove non-active users from appearing in search results, and can additionally promote user utilization of the platform. The number of editable future timeslots is preferably reduced in response to an activity parameter of the first user account falling below a parameter threshold, but can alternately be reduced in response to the occurrence of any other suitable reduction event.

The number of editable future timeslots associated with the first user account is preferably reduced with the passage of time, wherein editable timeslots are not added or enabled after the futuremost editable timeslot for the first user account, absent an adding event. In other words, the last unique time and date that the first user account can accept jobs can be held substantially constant, such that the editable time period (e.g., time period where a first user account can schedule and/or accept jobs) preferably decreases over time. Past timeslots (e.g., previously editable timeslots associated with a time and date before an instantaneous time) can be removed from the timetable, rendered uneditable, or removed from the set of future timeslots, or the extension of the editable timeframe 187 associated with the first user account can be otherwise prevented or limited.

In one example, a service provider is associated with a four-month window from a first time at the first time (e.g., when the service provider signs up for the platform), wherein the four-month window ends at a four-month date. As time passes, the number of future timeslots between the instantaneous time and the four-month date decreases. The four-month date is preferably substantially maintained unless the first user account satisfies a set of predetermined activity parameter conditions, whereupon the four-month date can be extended.

As shown in FIGS. 2, 6, 7, 8A, 8B, 9A, and 9B, the method can additionally include extending the editable timeframe or adding editable future timeslots to the timetable S820. The timeslots can be added or timeframe extended in response to satisfaction of an activity parameter threshold or in response to the occurrence of any other suitable extension event. As shown in FIG. 8A, a first number of editable timeslots or a first timeframe duration is preferably added to the set of editable timeslots or editable timeframe in response to the activity parameter satisfying a first parameter threshold, while a second number of editable timeslots or a second timeframe duration is preferably added to the set of editable timeslots or editable timeframe in response to the activity parameter failing the parameter threshold, as shown in FIG. 8B. The second number of editable timeslots (or timeframe duration extension) can be predetermined, automatically determined based on the activity parameter value, or otherwise determined. For example, the second number of editable timeslots can be automatically determined based on the difference between the activity parameter value and the first parameter threshold, based on whether the activity parameter satisfies a second parameter threshold (e.g., wherein the second parameter threshold can be easier to meet, and associated with a lower number of editable timeslots), or determined in any other suitable manner. The second parameter is preferably lower than the first parameter threshold, but can alternatively be equal to or higher than the first parameter threshold. The first and/or second parameter thresholds can be the same across user accounts of the first set, different across user accounts of the first set, be the same for user accounts of the first and second set, be different for the first set of user accounts and second set of user accounts, or vary in any other suitable manner.

The activity parameter can be the frequency of calendar updating, frequency of calendar visits, frequency of profile updating, frequency of searching, response time (e.g., time between availability request sending and response receipt), ratio of accept to decline responses, or any other suitable parameter indicative of platform use. The activity parameter threshold can be established by a platform administrator, automatically determined based on peer activity parameters (e.g., wherein the activity parameter threshold can be automatically adjusted in response to the mean or median activity parameter value for the first set of user accounts changing), or determined in any other suitable manner. The editable timeframe can be extended or the future timeslots added in response to one or more activity parameters satisfying or surpassing the respective activity parameter threshold. Different activity parameters can be monitored and/or used for timeframe extension purposes for different user accounts, different geographic regions, or any other suitable different user account population. However, the editable timeframe can be extended or the future timeslots added in response to the occurrence of any other suitable addition event.

Extending the editable timeframe or adding editable future timeslots S820 can additionally include monitoring an activity parameter of the first user account on the service provider platform S822. The activity parameter is preferably monitored by recording the actions taken by the first user account on the platform, but can be otherwise monitored. The activity parameter of the first user account is preferably monitored over a shorter time period (e.g., a second time period) than that defined by the editable future timeslots instantaneously available to the first user account, but can alternatively be monitored over any other suitable timeframe. For example, the activity parameter can be monitored over a time period of a day when the editable time period is four months.

The new timeslots can be added, or the editable timeframe extended, at a rate substantially equal to the monitoring time period, at a rate unequal to the monitoring time period, or at any other suitable rate. The rate is preferably constant, but can alternatively vary. For example, a set of new timeslots substantially equivalent to a day can be added, or the editable timeframe extended a day, in response to the activity parameter for the past day satisfying the parameter threshold. In an alternative example, a set of new timeslots substantially equivalent to a day can be added, or the editable timeframe extended a day, in response to the activity parameter for the past month satisfying the parameter threshold. The new timeslots can be added or the timeframe extended at a rate substantially equal to the passage of time, or can be added at a rate independent of the passage of time. For example, new 30-minute timeslots can be added every 30 minutes. In a second example, a new block of timeslots representing a week can be added after a week has passed. In an alternative example, a new block of timeslots representing a week can be added every two weeks. However, the timeslots can be added or the editable timeframe extended at any other suitable frequency.

The new timeslots and/or extended editable timeframe preferably substantially cooperatively maintain the first time period (e.g., the time period initially assigned to the user account) with the remaining future timeslots, such that the total time period cooperatively defined by the new set of future timeslots (e.g., including the remaining timeslots and new timeslots) is substantially equal to the first time period, as determined from an instantaneous time. However, the new timeslots and/or extended editable timeframe can alternatively cooperatively define a different time period with the remaining future timeslots. For example, the editable timeframe can be extended one month after two months have passed, such that the new editable time period is three months.

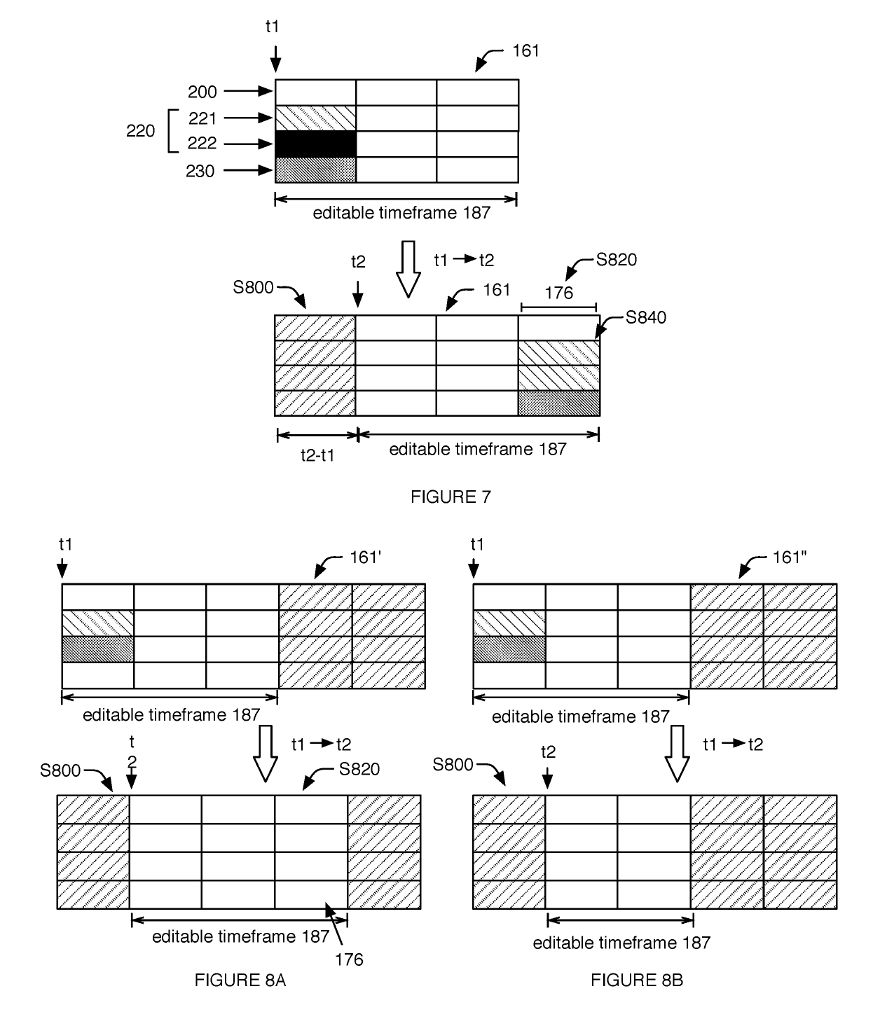

As shown in FIG. 7, the method can additionally include automatically assigning statuses to the newly added timeslots S840. The statuses are preferably assigned based on one or more patterns associated with the respective user account, but can alternatively be assigned in any other suitable manner. The patterns can be automatically determined (e.g., learned) based on past timeslot statuses, received from the user (e.g., wherein the user assigns a recurrent status to a timeslot), or determined in any other suitable manner. The patterns can be unavailability patterns, availability patterns, booking patterns, and/or patterns of any other suitable timeslot status. For example, the platform can automatically determine that a service provider is typically unavailable during the evenings from Monday to Friday, but is typically available Saturday evenings and is typically booked with the second user account on Sunday evenings. The platform can automatically assign unavailable statuses to any new Monday to Friday evening timeslots added to the service provider calendar, assign an available status to the Saturday evening timeslot, and assign a booked status to the Sunday evening timeslot. The platform can additionally automatically generate and send a query to the first and second user accounts for any automatically generated bookings. The unavailable statuses that are automatically populated are preferably editable, but can alternatively be uneditable.

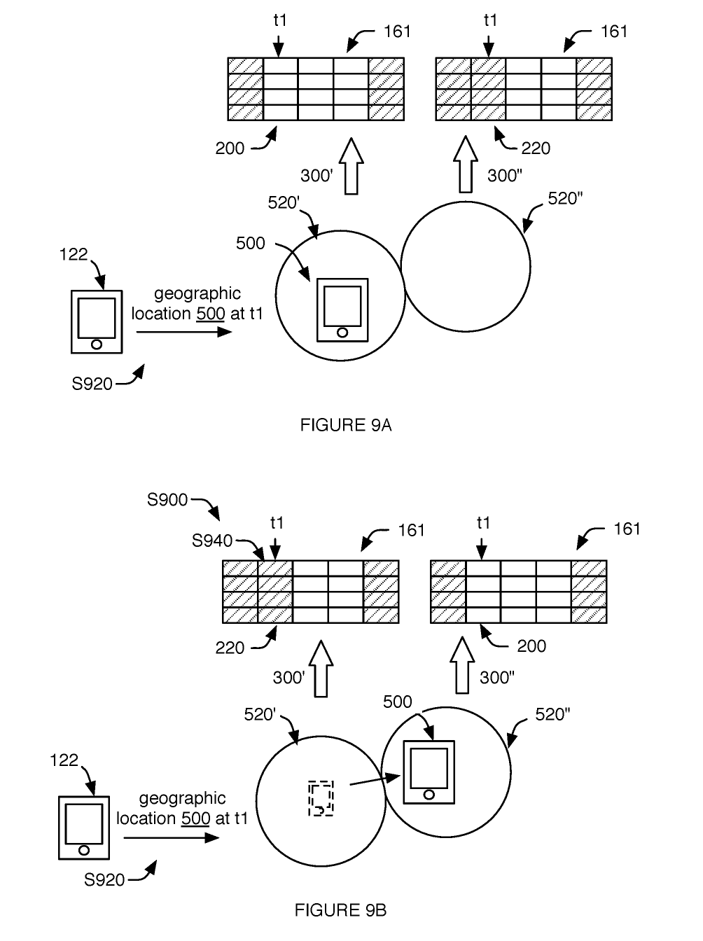

As shown in FIGS. 9A and 9B, the method can additionally include automatically associating a status with a timeslot based on a geographic location associated with the first user account S900. Automatically associating a status with a timeslot based on a geographic location associated with the first user account S900 can include receiving the geographic location S920 and assigning an unavailable status with a future timeslot in response to the geographic location falling outside a predetermined geographic region associated with the first user account S940. The future timeslot is preferably the set of timeslots associated with the geographic location, but can alternatively be a timeslot that is contiguous or adjacent a timeslot associated with the geographic location (e.g., associated with a time and/or date within a predetermined time period of the timeslot associated with the geographic location) or be any other suitable timeslot. This can function to accommodate for travel time or any other suitable delay. Automatically associating a status with a timeslot based on a geographic location can additionally or alternatively include automatically assigning an available status with a future timeslot (e.g., a timeslot previously marked unavailable because the service provider was out of the area) in response to the geographic location falling within a predetermined geographic region associated with the first user account.

The geographic location 500 can be a substantially instantaneous geographic location, a future geographic location, or any other suitable location. The geographic location can be received from a user (e.g., entered by the user), automatically determined by a user device (e.g., from a geolocation unit, such as a GPS unit), automatically determined from an external source (e.g., from an email or secondary social networking system account associated with the first user account), or otherwise determined. The geographic location identifier can be a set of geographic coordinates (e.g., longitude/latitude set), a venue name, a polity name (e.g., neighborhood, district, city, state, country etc.), an intersection of streets, or any other suitable identifier. The geographic location is preferably associated with a unique time and date, but can alternatively be unassociated with a specific time, associated with a recurring time, or associated with any other suitable temporal indicator. For example, the instantaneous geographic location can be associated with the instantaneous time. In another example, a future geographic location, determined based on the destination of a set of round trip plane tickets, can be associated with the duration of stay at the destination. However, the geographic location can be associated with any other suitable temporal indicator.

The geographic region 520 preferably encompasses a set of geographic locations (e.g., one or more geographic locations), but can alternatively encompass any other suitable representation of a physical area. The method can additionally include associating a geographic region with the first user account. One or more geographic regions can be associated with the first user account. The geographic regions can additionally be associated with a time (e.g., unique time and date, recurring time, etc.). For example, a first geographic region can be associated with the first user account during weekdays (e.g., wherein the first user account only accepts or is presented as available to secondary user accounts within the first geographic region for weekday timeslots), and a second geographic region can be associated with the first user account during weekends (e.g., wherein the first user account can accept or is presented as available to secondary user accounts within the second geographic region for weekend timeslots). The second geographic region is preferably encompasses different geographic locations than the first geographic region, and can encompass the first geographic region or be entirely separate from the first geographic region.

Associating a geographic region with the first user account can include receiving a geographic region from the first user account. Associating a geographic region with the first user account can additionally or alternatively include automatically determining the geographic region based on historical geographic location identifiers associated with the first user account and assigning the determined geographic region to the user account. The determined geographic region can encompass all or most of the historical geographic location identifiers associated with the first user account, but can alternatively encompass a subset of the historical geographic location identifiers sharing a common parameter (e.g., time, frequency of query responses, etc.) or encompass any other suitable set of historical geographic location identifiers. However, the geographic region can be otherwise associated with the first user account. The historical geographic location identifiers associated with the first user account can be past location identifiers that were received from a user device associated with the first user account, location identifiers of past jobs accepted by the first user account (e.g., location identifiers associated with past scheduling requests to which the first user account sent an accept response), or be any other suitable set of historical location identifiers.

In one variation of the method, the method includes associating a geographic region with a first user account, receiving a geographic location identifier associated with a first time from a first user account, and, in response to the geographic location identifier identifying a geographic location outside the geographic region, associating an unavailable status with future timeslots of the set that are within predetermined period of the first time.

In a second variation of the method, the method includes associating a first geographic region with a first user account, receiving a geographic location identifier associated with a first time from a first user account, and, in response to the geographic location identifier identifying a geographic location outside the first geographic region 520′, associating an unavailable status with timeslots within predetermined period of the first time for a first secondary user account (e.g., first service seeker) associated with the first geographic region, and associating an available status with timeslots within predetermined period of the first time for a second secondary user account (e.g., second service seeker) that is associated with a second geographic region 520″, wherein the geographic location identifier is encompassed by the second geographic region. The second geographic region 520″ can be associated or unassociated with the first user account. The platform preferably displays an interface showing the timeslots as unavailable in response to receipt of a request to display the first user account calendar from the first secondary user account (second user account), and displays an interface showing the timeslots as available in response to receipt of a request to display the first user account calendar from the first secondary user account (third user account). This can function to enable the service provider to provide service to service seekers, even though the service provider is outside of the first geographic region 520′.

The method can additionally include automatically generating and sending availability queries based on the activity parameters of the first user account (S760 and S780, respectively), as shown in FIG. 3. This can function to update the timetable without proactive user editing. The availability query is preferably generated for a timeslot associated with an available status, wherein the available status is preferably retained in response to receipt of an available response to the availability query, and an unavailable status is preferably assigned to the timeslot in response to receipt of an unavailable response to the availability query. If no response is received, the timeslot can retain the status associated with the timeslot at the time of availability query generation and/or sending, or can be associated with an unavailable status. The unavailable status is preferably editable, but can alternatively be non-editable. However, the availability query can be generated for an unavailable timeslot, a booked timeslot, or for any other suitable timeslot. The timeslot identified by the availability query is preferably a predetermined period of time after an instantaneous time (e.g., three days ahead), but can alternatively be any other suitable timeslot.

In one variation of the method, automatically generating and sending the availability queries includes automatically generating and sending an availability query for a timeslot in response to an activity parameter of the first user account falling below a predetermined threshold. In a second variation of the method, automatically generating and sending the availability queries includes automatically generating and sending an availability query for a timeslot in response to the ratio of a first and second activity parameter surpassing a threshold ratio (e.g., falling below or exceeding the threshold ratio). In a third variation of the method, automatically generating and sending the availability queries includes automatically generating an availability query for a timeslot at a predetermined frequency, wherein the predetermined frequency can be selected by the first user account, determined for the first set of user accounts, or otherwise determined. However, the availability queries can be generated and sent at any other suitable frequency. In one example of the method, automatically generating and sending the availability queries includes monitoring a first activity parameter for the first user account in association with the set of future timeslots (e.g., monitoring a calendar update frequency), monitoring a second activity parameter for the first user account on the service provider platform (e.g., monitoring a browsing, searching, or profile update frequency), generating and sending an availability query for a future timeslot in response to the first activity parameter falling below a first parameter threshold and the second activity parameter surpassing a second parameter threshold, and automatically populating the timeslots identified by the query based on the response, wherein the identified timeslot is associated with an unavailable status in response to receipt of an unavailable or decline response, and associated with an available status in response to receipt of an available or accept response. However, the timeslot statuses can be otherwise updated based on the activity parameters of the first user account.

In a specific example, the method returns a set of user account identifiers in response to a query identifying a time block, wherein each of the returned user accounts are associated with an available status for the identified time block (e.g., are available time blocks). Users associated with unavailable statuses for the identified time block are preferably not returned, but can alternatively also be returned. The method can additionally include extending the editable time period (e.g., to maintain the editable time duration) by adding new time blocks, wherein the new time blocks can be periodically added, added at the same rate of time passing, or added at any other suitable frequency. The method can additionally include automatically assigning statuses (e.g., available statuses, unavailable statuses, booked statuses, etc.) to the new time blocks based on a set of availability or unavailability parameters or rules, which can function to maintain the availability (e.g., number of available time slots) for the first user account. The availability or unavailability parameters or rules are preferably specific to the first user account but can alternatively be global parameters or rules, specific to a category of user accounts to which the first user account belongs, or be any other suitable set of parameters or rules. The availability or unavailability parameters or rules can be received from the first user account, automatically determined from past availability patterns for the first user account (e.g., based on user-entered scheduling information, user responses to job requests, user bids on job postings, etc.), automatically determined based on availability parameters for a population of users, or otherwise determined. New time slots can, by default, be assigned an unavailable status, or be assigned any other suitable status. The automated status assignment can be halted, gradually diminished, or otherwise adjusted in response to first user account activity on the service platform falling below a threshold parameter value. This can function to decay the availability of the first user account and reduce the number of times the first user account will appear in query results. The automated status assignment can be increased, restarted, or otherwise adjusted in response to detection of increased user activity on the service platform or in response to any other suitable condition being met.

An alternative embodiment preferably implements the above methods in a computer-readable medium storing computer-readable instructions. The instructions are preferably executed by computer-executable components preferably integrated with a service provider system. The service provider system can include an activity parameter monitoring system that functions to monitor the activity of a first user account on the calendaring management system, a calendar management system that functions to selectively assign an unavailability status to timeslots in response to service cancellations and declines, a notification system that functions to automatically generate notifications to prompt the first user account to indirectly update the calendar by responding to a notification associated with a set of timeslots, a scoring system that functions to score the first user account relative to a set of other accounts, and a search system that returns user accounts having availabilities during a specified timeslot, wherein the user accounts can be ordered according to the respective scores. The computer-readable medium can be stored on any suitable computer readable media such as RAMs, ROMs, flash memory, EEPROMs, optical devices (CD or DVD), hard drives, floppy drives, or any suitable device. The computer-executable component is preferably a processor but the instructions can alternatively or additionally be executed by any suitable dedicated hardware device.

Although omitted for conciseness, the preferred embodiments include every combination and permutation of the various system components and the various method processes.

As a person skilled in the art will recognize from the previous detailed description and from the figures and claims, modifications and changes can be made to the preferred embodiments of the invention without departing from the scope of this invention defined in the following claims.

We claim:

1. A method for automated calendar management on a service platform, the method comprising:
associating a set of available time blocks and unavailable time blocks to a first user account on the service platform according to availability parameters associated with the first user account, the set of available and unavailable time blocks cooperatively extending over an editable time period having a predetermined time duration, wherein time blocks outside of the editable time period cannot be edited by the first user account;
monitoring an activity parameter for the first user account indicative of first user account activity on the service platform;
extending the editable time period by adding new time blocks as time passes, such that the editable time period extending from an instantaneous time has a time duration of at least the predetermined time duration;
in response to the activity parameter satisfying a first parameter threshold, assigning available statuses to the new time blocks according to the availability parameters;
in response to the activity parameter falling below the first parameter threshold, decaying the available time blocks associated with the first user account by assigning unavailable statuses to the new time blocks;
receiving a scheduling request identifying an available time block associated with the first user account from a second user account;
sending an availability query based on the scheduling request to the first user account;
in response to receipt of a decline response to the availability query from the first user account, changing the available time block to an unavailable time block; and
in response to receipt of an accept response to the availability query from the user account, changing the available time block to a booked time block and associating an identifier for the second user account to the booked time block.

2. The method of claim 1, further comprising: in response to the instantaneous time falling within a predetermined time period before the booked time block, sending a confirmation query to the first user account.

3. The method of claim 2, further comprising: in response to receipt of a cancellation response to the confirmation query from the first user account:
changing the booked time block to an unavailable time block; and
decreasing a score associated with the first user account, wherein the score is based on the activity parameter.

4. The method of claim 1, wherein assigning available statuses to the new time blocks according to the availability parameters comprises automatically learning an availability pattern from past time blocks associated with the first user account and assigning the available statuses to the new time blocks according to the availability pattern.

5. The method of claim 1, further comprising:
receiving a cancellation request from the first user account for a booked time block; and
changing the booked time block to an unavailable time block.

6. The method of claim 5, further comprising:
identifying a set of user accounts having available time blocks sharing the time and date of the booked time block, the set of user accounts connected to the first user account on the service provider platform; and
sending a notification to the second user account associated with the booked time block, the notification comprising an identifier for the set of user accounts.

7. A method for automated calendar management on a service platform, the method comprising:
for each of a plurality of user accounts, assigning an available status to a number of editable time blocks associated with the user account according to availability parameters associated with the respective user account, wherein the editable time blocks cooperatively define an editable time period spanning a predetermined time duration, wherein each user account cannot edit time blocks outside of the editable time period;
identifying a subset of user accounts from the plurality in response to a query identifying a queried time block, wherein the identified user accounts have available statuses associated with the queried time block;
monitoring an activity parameter for a first user account of the plurality indicative of user account activity on the service provider platform;
extending the editable time period by adding new editable time blocks, such that the editable time period extends at least the predetermined time duration from an instantaneous time;
maintaining a number of editable time blocks having available statuses within the editable time period associated with the first user account in response to the activity parameter satisfying a first parameter threshold;
decaying the number of editable time blocks having available statuses within the editable time period associated with the first user account in response to the activity parameter falling below the first parameter threshold; and
after decaying the number of editable time blocks having available statuses within the editable time period associated with the first user account, increasing the number of editable time blocks within the editable time period associated with the first user account in response to the activity parameter satisfying a second parameter threshold.

8. The method of claim 7, further comprising:
receiving, from second user account different from the first user account, a scheduling request identifying a time block associated with an available status for a first user of the plurality;
sending an availability query based on the scheduling request to the first user account;
in response to receiving a decline response to the availability query from the first user account, assigning an unavailable status to the time block; and
in response to receiving an accept response to the availability query from the first user account, assigning a booked status and an identifier for the second user account to the time block.

9. The method of claim 7, wherein the second parameter threshold is lower than the first parameter threshold.

10. The method of claim 7, further comprising:
generating a score for the first user account based on the activity parameter;
receiving a search request from the second user account; and
presenting an identifier for the first user account in a list of user account identifiers, wherein a position of the first user account identifier in the list is determined based on the score.

11. The method of claim 7, wherein the activity parameter comprises a time block update frequency.

12. The method of claim 7, wherein maintaining a number of editable time blocks having available statuses within the editable time period associated with the first user account comprises:
identifying a pattern of unavailability from past time blocks associated with the first user account; and
automatically assigning unavailable statuses to a subset of the new time blocks, based on the identified pattern of unavailability.

13. The method of claim 7, further comprising:
monitoring a first activity parameter for the first user account in association with a set of future time blocks comprising time blocks after an instantaneous time;
monitoring a second activity parameter for the first user account on the service provider platform; and
generating an availability query for a future time block of the set associated with an unavailable status in response to the first activity parameter falling below a first parameter threshold and the second activity parameter surpassing a second parameter threshold.

14. The method of claim 7, further comprising:
associating a geographic region with the first user account;
receiving a geographic location identifier from the first user account at a first time; and
in response to the geographic location identifier identifying a geographic location outside the geographic region, associating an unavailable status with future time blocks associated with the user account falling within a predetermined period after the first time.

15. The method of claim 14, wherein associating a geographic region with the first user account comprises automatically determining the geographic region based on historical geographic location identifiers associated with the first user account.

16. The method of claim 14, comprising:
associating a second geographic region with the first user account, the second geographic region different from the first geographic region;
in response to receipt of a second geographic location identifier identifying a geographic location within the second geographic region and outside the first geographic region:
assigning an unavailable status to the first user account time blocks in association with the first geographic region; and
maintaining any available statuses for the first user account time blocks in association with the second geographic region;

17. The method of claim 16, further comprising:
receiving, from a second user account associated with the first geographic region, a first query for a time block for the first user account, the time block associated with an unavailable status for the first geographic region and with an available status for the second geographic region;
receiving a second query for the time block from a third user account associated with the second geographic region; and
displaying the time block as unavailable to the second user account and displaying the time block as available to the third user account.

18. The method of claim 7, wherein the time blocks each cover the same time period.

19. The method of claim 14, further comprising:
receiving a job request identifying a time block and a geographic region from the second user account;
receiving a job bid on the job request from the first user account, the first user account associated with an unavailable status for the time block; and
assigning an available status to the time block for the first user account.

20. The method of claim 19, wherein a first user associated with the first user account is a service provider and a second user associated with the second user is a service seeker.
